(19) United States
(12) Patent Application Publication
(10) Pub. No.: US 2013/0241836 A1
(43) Pub. Date: Sep. 19, 2013

(54) KEYBOARD AND COMPUTING DEVICE

(71) Applicant: ZHOU CHEN, Shenzhen City (CN)

(72) Inventor: ZHOU CHEN, Shenzhen City (CN)

(73) Assignees: HON HAI PRECISION INDUSTRY CO., LTD., Tu-Cheng (TW); FU TAI HUA INDUSTRY (SHENZHEN) CO., LTD., ShenZhen City (CN)

(21) Appl. No.: 13/600,118

(22) Filed: Aug. 30, 2012

(30) Foreign Application Priority Data
Mar. 19, 2012 (CN) 201210072047.X

(51) Int. Cl. G06F 3/02

(52) U.S. Cl. 345/168

(57) ABSTRACT

A keyboard includes a main keypad, a numerical keypad, a processor, and a detector. In an input mode, the processor processes input information of the main keypad or input information of the numerical keypad and outputs the processed input information of the main keypad or the processed input information of the numerical keypad to a computer. In a calculator mode, the processor performs a numerical calculation upon the input information of the numerical keypad. The detector detects operation states of the computer and the processor is controlled to switch between the input mode and the calculator mode according to the detected operation states.

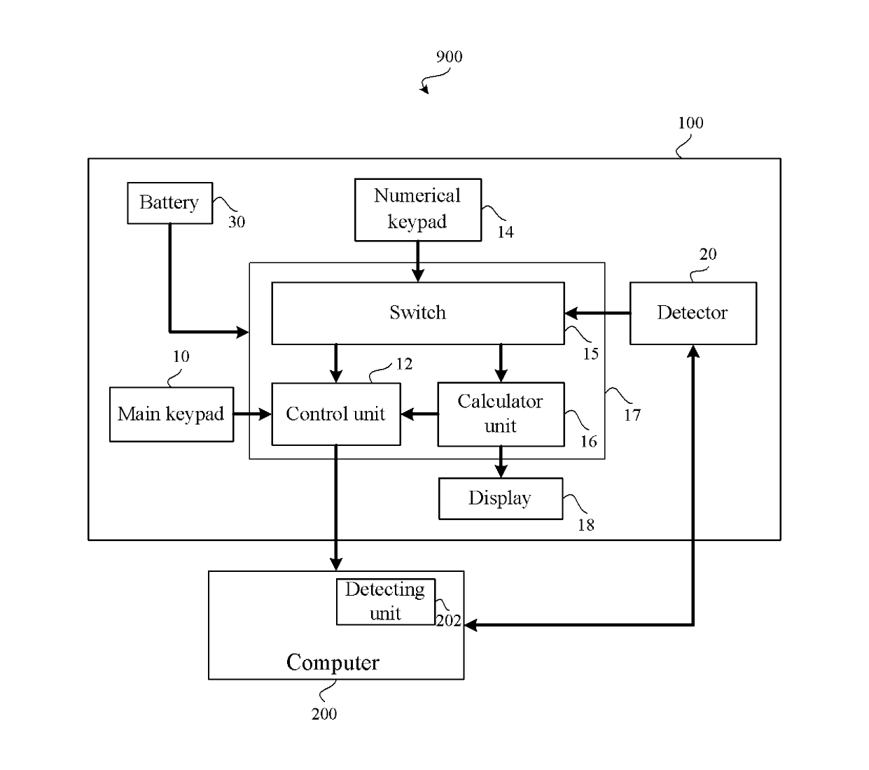

### BACKGROUND

1. Technical Field

The disclosed embodiments relate to keyboards, and particularly to a keyboard with a numerical calculation function for a computer and a computing device.

2. Description of Related Art

A contemporary keyboard as an input device for a computer has very simple functions. Often, people using a computer may like to perform numerical calculations. However, contemporary computers are not capable of processing numeral calculations via the keyboard directly. Therefore, it is necessary for people to get a calculator or open a program in the computer to perform calculations.

What is needed, therefore, is a keyboard for a computer and a computing device which can overcome the above problems.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout one view.

The FIGURE is a block diagram of a keyboard in accordance with one embodiment.

### DETAILED DESCRIPTION

Referring to the FIGURE, a computing device 900 of the embodiment is shown. The computing device 900 includes a keyboard 100 and a computer 200. The computer 200 is a standard unit known in the art. The keyboard 100 is connected to the computer 200 via a bi-direction communications interface (not shown), such as a standard PC/AT computer cable, as is used in many personal computer configurations. Other known interfaces can be used, such as a PS/2 interface or an infrared interface for wireless communication, which are not shown.

The keyboard 100 includes a main keypad 10, a numerical keypad 14, a processor 17, a display 18, and a detector 20. The processor 17 is capable of switching between an input mode and a calculator mode. In the input mode, the processor 17 is capable of processing input information of the main keypad 10 or input information of the numerical keypad 14 and outputting the processed input information of the main keypad 10 or the processed input information of the numerical keypad 14 to the computer 200. In the calculator mode, the processor 17 is capable of performing a numerical calculation upon the input information of the numerical keypad 14. The display 18 is used for displaying the input information of the numerical keypad 14 and a result of the numerical calculation.

The detector 20 detects operation states of the computer 200 according to a supply voltage of the computer 200, and controls the processor 17 to switch between the input mode and the calculator mode according to the detected operation states. In this embodiment, the operation states of the computer 200 include a power off state in which the computer 200 is powered off, a power on state in which the computer 200 is powered on, and a document editing state in which the computer 200 edits a document. The detector 20 is a voltage detector. When the supply voltage of the computer 200 is detected by the detector 20, the computer 200 is in the power on state. When the detector 20 detects that there is no supply voltage of the computer 200 (e.g., about zero voltage in one example), the computer 200 is in the power off state. The determination of whether the computer 200 is in the document editing state is explained as follows.

In a first situation, the detector 20 generates a command when detecting that the computer 200 is in the power on state. In a first embodiment, the computer 200 includes a detecting unit 202 that detects whether the computer 200 is in the document editing state according to the command from the detector 20, and generates a feedback signal when detecting that the computer 200 is in the document editing state. The detector 20 controls the processor 17 to be switched to the calculator mode in response to the feedback signal. In the document editing state, the computer 200 edits the document, such as WORD document, POWERPOINT document, or EXCEL document, etc., in response to user's input operations. In a second embodiment, the processor 17 is switched to the input mode according to the command from the detector 20.

In detail, in a second situation, the keyboard 100 further includes a battery 30. When the detector 20 detects that the computer 200 is in the power off state, the processor 17 is switched to the calculator mode. The battery 30 powers the keyboard 100 when the keyboard 100 is in the calculator mode.

Furthermore, the processor 17 includes a control unit 12 connected to the main keypad 10, a switch 15, and a calculator unit 16. The calculator unit 16 is connected to the control unit 12. The numerical keypad 14 is connected to the control unit 12 and the calculator unit 16 via the switch 15. The detector 20 controls the switch 15 to establish an electrical connection between the numerical keypad 14 and the control unit 12 and cutoff the electrical connection between the numerical keypad 14 and the calculator unit 16 or controls the switch 15 to establish the electrical connection between the numerical keypad 14 and the calculator unit 16 and cutoff the electrical connection between the numerical keypad 14 and the control unit 12 according to the detected operation states.

For example, when the detector 20 detects that the computer 200 is powered on, the detector 20 controls the switch 15 to establish the electrical connection between the numerical keypad 14 and the calculator unit 16 and cutoff the electrical connection between the numerical keypad 14 and the control unit 12. Therefore the calculator unit 16 performs the numerical calculation upon the input information of the numerical keypad 14. The control unit 12 processes a result of the numerical calculation and outputs the processed result of the numerical calculation to the computer 200.

In detail, the display 18 is connected to the calculator unit 16, the display 18 is configured for displaying the input information of the numerical keypad 14 and a result of the numerical calculation.

Because the keyboard 100 can be switched to the calculator mode, the computer 200 is capable of processing numeral calculations via the keyboard 100 directly, and is convenient for the users.

Alternative embodiments will become apparent to those skilled in the art without departing from the spirit and scope of what is claimed. Accordingly, the present disclosure should not be deemed to be limited to the above detailed description, but rather only by the claims that follow and the equivalents thereof.

What is claimed is:

1. A keyboard, comprising:
a main keypad;
a numerical keypad;
a processor configured to process data in an input mode and a calculator mode; and
a detector;
wherein the processor, in the input mode, processes input information of the main keypad or input information of the numerical keypad and outputs the processed input information of the main keypad or the processed input information of the numerical keypad to a computer; and the processor, in the calculator mode, performs a numerical calculation upon the input information of the numerical keypad;
wherein the detector detects operation states of the computer, and controls the processor to switch between the input mode and the calculator mode according to the detected operation states.

2. The keyboard of claim 1, wherein the processor processes a result of the numerical calculation and outputs the processed result of the numerical calculation to the computer.

3. The keyboard of claim 1, further comprising a battery, wherein the computer is in a power off state when the detector detects that there is no supply voltage of the computer, the detector controls the processor to be in the calculator mode when detecting that the computer is in the power off state; the battery powers the keyboard when the keyboard is in the calculator mode.

4. The keyboard of claim 1, wherein the computer is in a power on state when the detector detects a supply voltage of the computer, the detector controls the processor to be in the input mode when detecting that the computer is in the power on state.

5. The keyboard of claim 1, further comprising a display that displays the input information of the numerical keypad and the result of the numerical calculation.

6. The keyboard of claim 1, wherein the processor comprises a switch, a control unit connected to the main keypad, and a calculator unit, the numerical keypad is connected to the control unit and the calculator unit via the switch, the detector controls the switch to establish an electrical connection between the numerical keypad and the control unit and cutoff the electrical connection between the numerical keypad and the calculator unit or controls the switch to establish an electrical connection between the numerical keypad and the calculator unit and cutoff the electrical connection between the numerical keypad and the control unit according to the detected operation states.

7. The keyboard of claim 6, wherein the calculator unit is connected to the control unit, when the detector detects that the computer is powered on, the detector controls the switch to establish an electrical connection between the numerical keypad and the calculator unit and cutoff the electrical connection between the numerical keypad and the control unit, the calculator unit performs the numerical calculation upon the input information of the numerical keypad; the control unit processes a result of the numerical calculation and outputs the processed result of the numerical calculation to the computer.

8. The keyboard of claim 7, further comprising a display connected to the calculator unit, the display configured for displaying the input information of the numerical keypad and the result of the numerical calculation.

9. A computing device comprising a computer and a keyboard connected to the computer, the keyboard comprising:
a main keypad;
a numerical keypad;
a processor configured to process data in an input mode and a calculator mode; and
a detector;
wherein the processor, in the input mode, processes input information of the main keypad or input information of the numerical keypad and outputs the processed input information of the main keypad or the processed input information of the numerical keypad to the computer; and the processor, in the calculator mode, performs a numerical calculation upon the input information of the numerical keypad;
wherein the detector detects operation states of the computer, and controls the processor to switch between the input mode and the calculator mode according to the detected operation states.

10. The computing device of claim 9, wherein the computer is in a power on state when the detector detects a supply voltage of the computer, the detector generates a command when detecting that the computer is in the power on state, the computer comprises a detecting unit for detecting whether the computer is in a document editing state according to the command, and generating a feedback signal when detecting that the computer is in the document editing state, the detector further controls the processor to be in the calculator mode in response to the feedback signal.

11. The computing device of claim 9, wherein the processor processes a result of the numerical calculation and outputs the processed result of the numerical calculation to the computer.

12. The computing device of claim 9, further comprising a battery, wherein the computer is in a power off state when the detector detects that there is no supply voltage of the computer, the detector controls the processor to be in the calculator mode when detecting that the computer is in the power off state; the battery powers the keyboard when the keyboard is in the calculator mode.

13. The computing device of claim 9, wherein it is determined that the computer is in a power on state when a supply voltage of the computer is detected by the detector, and the detector controls the processor to be in the input mode when detecting that the computer is in the power on state.

14. The computing device of claim 9, wherein the keyboard further comprises a display that displays the input information of the numerical keypad and the result of the numerical calculation.

15. The computing device of claim 9, wherein the processor comprises a switch, a control unit connected to the main keypad, and a calculator unit, the numerical keypad is connected to the control unit and the calculator unit via the switch, the detector controls the switch to establish an electrical connection between the numerical keypad and the control unit and cutoff the electrical connection between the numerical keypad and the calculator unit or controls the switch to establish the electrical connection between the numerical keypad and the calculator unit and cutoff the electrical connection between the numerical keypad and the control unit according to the detected operation states.

16. The computing device of claim 15, wherein the calculator unit is connected to the control unit, when the detector detects that the computer is powered on, the detector controls the switch to establish the electrical connection between the numerical keypad and the calculator unit and cutoff the electrical connection between the numerical keypad and the control unit, the calculator unit performs the numerical calculation upon the input information of the numerical keypad; the control unit processes a result of the numerical calculation and outputs the processed result of the numerical calculation to the computer.

17. The computing device of claim 16, wherein the keyboard further comprises a display connected to the calculator unit, the display is configured for displaying the input information of the numerical keypad and the result of the numerical calculation.
